(19) United States
(12) Patent Application Publication
(10) Pub. No.: US 2011/0225840 A1
(43) Pub. Date: Sep. 22, 2011

(54) METHOD OF DRYING A POLYMERIC MATERIAL

(76) Inventor: Roland Lofgren, Helsingborg (SE)

(21) Appl. No.: 12/672,268

(22) PCT Filed: Oct. 23, 2008
(86) PCT No.: PCT/US08/80848

§ 371 Date: Feb. 4, 2010

Related U.S. Application Data
(60) Provisional application No. 60/981,832, filed on Oct. 23, 2007.

(51) Int. Cl. F26B 3/34

(52) U.S. Cl. 34/267

(57) ABSTRACT

The method is for drying a material. A drying device is provided that has a heater disposed above a movable carrier and a fan device. The movable carrier carries the material to be dried. The material has a first temperature. A fluid, such as air is blown across the material by the fan device. The material is heated by the heater.

### TECHNICAL FIELD

The present invention relates to a method for effectively drying polymeric and other materials.

### BACKGROUND AND SUMMARY OF THE INVENTION

Before a material, such as a polymeric material, is processed, it is important to remove contaminants and moisture from the material to prevent defects such as warping, uneven shrinkage and undesirable discoloration. Many devices have been developed in the past that remove such contaminants and moisture. However, such conventional devices are often very expensive to manufacture, unreliable, energy waste and require long production cycles. It often takes a very long time to dry thermoplastics such as nylon. It is not unusual to have to dry nylon granules for many hours before the nylon granules are sufficiently dry. There is a need for an inexpensive and reliable device for heating and drying a material to remove moisture before it is further processed.

The method of the here presented invention provides a solution to the above outlined problems. A drying device is provided that has an infrared heater or any source of radiation or other heating device disposed above a movable carrier, such as a rotatable disc. The movable carrier movably carries the material to be dried or heated. The material has a first temperature. A fluid, such as air is blown across the material by a fan device. The infrared heater or any source of radiation or other heating device induces a release of water molecules from the material. The fluid removes the water molecules disposed between the material and the infrared source or any source of radiation or other heating device.

### BRIEF DESCRIPTION OF THE DRAWINGS

FIG. 1 is a cross-sectional side view of the drying device of the present invention;

FIG. 2 is a cross-sectional front view of the drying device of the present invention; and

FIG. 3 is a cross-sectional top view of the drying device of the present invention.

### DETAILED DESCRIPTION

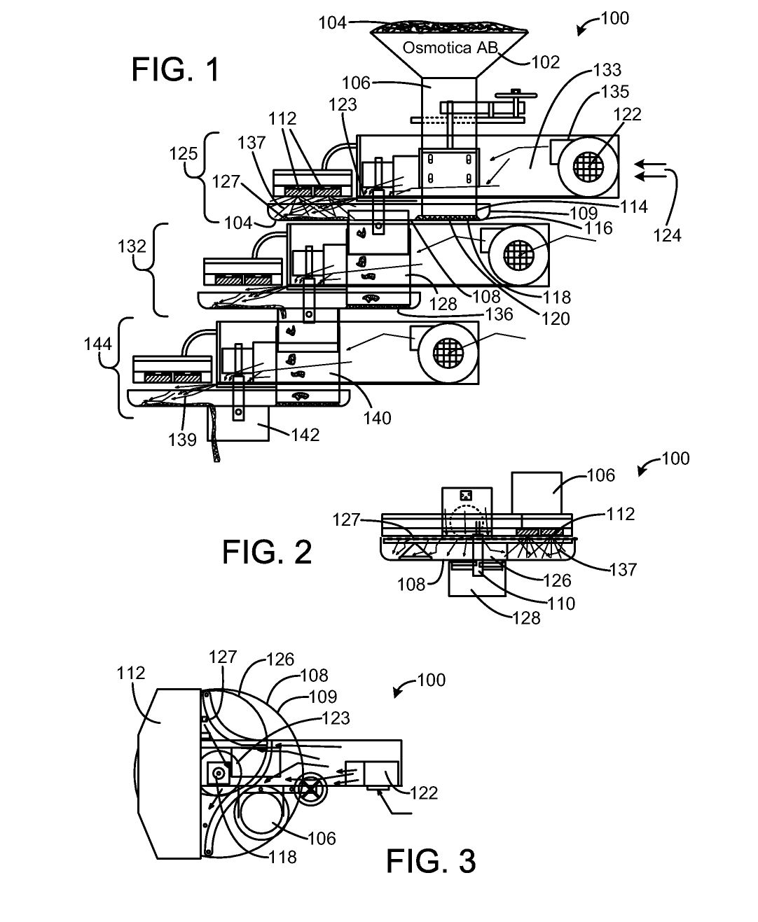

The method of the present invention relates to an effective and quick way of drying or heating hydroscopic and non hydroscopic materials. FIG. 1 is a cross-sectional side view of the drying device 100 of the present invention. The device 100 has a feeder 102 where the material pellets, granulates or granules 104, drop or fall down by gravity through a first tube 106 onto a first rotatable disc 108 driven by a rotatable axle 110. The disc 108 has a peripheral upwardly extending sidewall 109. Preferably, the disc 108 rotates slowly such as one rotation per minute. The tube 106 has an end 114 that terminates at a gap 116 above the top surface 118 of the disc 108. The gap 116 is, preferably, set based on the size of the granules 104 so there is only room for one layer 120 of the pellet material 104 on the disc 108. The layer 120 is preferably not higher than or slightly higher than a maximum height of the granules 104 so there is no room for a granule to sit on top of another granule. In other words, the gap 116 is less than the thickness of two granules placed on top of one another but more than the thickness of one granule lying on the disc 108. A set of heaters 112, such as infrared heaters, or any source of radiation or other heating device are disposed above the disc 108 and the layer 120 of the granules 104. The infrared heaters activate or vibrate water molecules 137 on the surface and inside of the granules 104 to release the water molecules from the granules so the water molecules are disposed between the heaters 112 and the top surfaces of the granules 104 and thus be exposed to the radially outwardly flowing fluid 139 that remove the water molecules 137. The heaters 112 may cover or extend around about half of the disc surface 108, as best shown in FIG. 3.

A temperature sensor 127 is disposed at the end of the heaters 112 that measures the temperature of the surface of the granules 104 disposed on the rotating disc 108 without touching the granules and sends signals back to a temperature-regulator that then controls the heaters 112 to make sure the heaters are heating the granules to the correct or desirable temperature.

A fan device 122 is disposed at one end of the device 100 that sucks in an outside gas or air 124 so that the air flows into a cavity 133 of a housing 135 and in through a central opening 123 at the axle 110. The gas may be nitrogen gas or especially clean air or any other suitable fluid. In this way, the fan device 122 creates an over-pressure inside the housing 135 that forces the air 124 through the opening 123 and radially outwardly above the granules 104. The central opening 123 guides the air to flow radially outwardly across the layer 120 of the granules 104 towards the peripheral sidewall 109 of the disc 108 to cool the granules 104 and to drive away moisture or water molecules 137 released from the granules 104 as the granules are being warmed or heated by the infrared heaters or any source of radiation or other heating device 112. The warm granules have a first temperature that is higher than a temperature of the air 124. The above components may be said to form a first module 125. The cooler air 124 may also be used to cool a gearbox and motor of the first module.

The disc 108 has a scraper 126 that scrapes the granules 104 towards a center opening 123 of the disc and into a second tube 128 so that the granules 104 fall by gravity onto a second rotatable disc 130 of a second module 132 disposed below the first disc 108. As the granules tumble down the second tube 128 they are preferably turned so that the granules land upside down compared to the way the laid on the first disc 108. The second module 132 has heaters 134, such as infrared heaters, or any source of radiation or other heating device disposed above the one layer 136 and a scraper 138 so that the second module 132 is substantially similar to the first module 125.

The scraper 138 scrapes the granules into a third tube 140 so that the granules fall onto a third rotatable disc 142 of a third module 144 disposed below the first module 125 and the second module 132. The third module 144 is preferably identical to the second module 132. The use of many modules and repeating the process many times makes the granules 104 drier. It may also be possible run the granule material many times through the same module to make the material drier. The use of modules makes it very easy to clean the cleaning device 100 when it is time to dry a different material.

While the present invention has been described in accordance with preferred compositions and embodiments, it is to be understood that certain substitutions and alterations may be made thereto without departing from the spirit and scope of the following claims.

1. A method for drying a material, comprising:
providing a drying device having an infrared heater or any source of radiation or other heating device disposed above a movable carrier and a fan device,
the movable carrier movably carrying a material to be dried relative to the infrared heater,
the infrared heater heating the material to a first temperature,
the infrared heater releasing water molecules from the material, the material being heated by the infrared heater to a first temperature,
the fan device blowing a fluid across the material, the fluid having a second temperature being lower than the first temperature of the material and the fluid removing water molecules disposed between the material and the infrared heater to dry the material.

2. The method according to claim 1 wherein the method further comprises the fluid flowing radially outwardly from a center of a disc towards a peripheral wall.

3. The method according to claim 1 wherein the method further comprises laying one layer on the movable carrier.

4. The method according to claim 1 wherein the method further comprises rotating the movable carrier.

5. The method according to claim 1 wherein the method further comprises the infrared heater or any source of radiation or other heating device activating water molecules on and inside and between granules to release the water molecules from the granules or any free flowing material.

6. The method according to claim 1 wherein the method further comprises fluid removing water molecules from the granules.

7. The method according to claim 1 wherein the method further comprises a scraper scraping the granules towards a central opening to permit the granules to fall through a second tube by gravity onto the movable carrier.

8. The method according to claim 7 wherein the method further comprises the fan device creating an over-pressure inside a housing to drive air towards the central opening and into the second tube.

9. The method according to claim 7 wherein the method further comprises the central opening guiding the fluid radially outwardly towards a peripheral sidewall.

10. The method according to claim 7 wherein the method further comprises a scraper scraping the granules into a third tube so that the granules fall by gravity onto a third rotatable disc.
